(19) United States
(12) Patent Application Publication
(10) Pub. No.: US 2015/0236468 A1
(43) Pub. Date: Aug. 20, 2015

(54) METHOD FOR GENERATING OR AMPLIFYING SEVERAL WAVELENGTHS OF LASER RADIATION IN A SINGLE OPTICAL CAVITY

(71) Applicant: Integrated Optics, UAB, Vilnius (LT)

(72) Inventor: Jonas Jonuska, Vilnius (LT)

(73) Assignee: Integrated Optics, UAB, Vilnius (LT)

(21) Appl. No.: 14/421,826

(22) PCT Filed: Oct. 23, 2012
(86) PCT No.: PCT/IB2012/055815

§ 371 Date: Feb. 14, 2015

(30) Foreign Application Priority Data
Aug. 16, 2012 (LT) 2012-075

(51) Int. Cl. H01S 3/00

(52) U.S. Cl. CPC H01S 3/0092

(57) ABSTRACT

An object of the present invention is to provide a laser source capable of simultaneously generating several wavelengths of radiation at desired power ratio between each other. Said radiation of two or more wavelengths can be used for mixing said wavelengths in a non-linear optical media in order to achieve different wavelength radiations than those amplified in the gain media. In the most preferred embodiment, a laser source comprises a dispersive optical element, placed in an optical cavity, having a single optical axis. The dispersive element causes different wavelengths of radiation to travel in slightly different optical paths through the dispersive element. Tuning of the laser is performed by moving or tilting the dispersive element with respect to the axis of the cavity. As a result, desired ratio or proportions of average power are achieved for each of said wavelengths. Having the ability to change the power ratio is important for achieving simultaneous generation of several wavelengths in a single gain media, thus avoiding depletion of the exited state by the dominant wavelength.

### FIELD OF INVENTION

This invention relates to lasers. More particularly it relates to laser sources capable emitting radiation of several wavelengths simultaneously or generating desired wavelengths by means of wave mixing in non-linear media.

### BACKGROUND OF INVENTION

Possibility of generating several wavelengths in a single laser device is of great interest and number of applications are available. Many bio-tech applications and tools are rather limited to the wavelengths currently available, thus some fluorescent dyes cannot be used or such parameters as absorption, distinction, Raman scattering or similar cannot be measured for wavelengths, which are not standard for diode pumped solid state lasers or laser diodes. Most popular designs of DPSS lasers feature 1064 nm, 1030 nm, 532 nm, 515 nm, which refer to fundamental, second harmonics of Neodymium or Ytterbium doped gain media, furthermore, third and higher harmonics are pretty common.

Widely tunable lasers, such as optical parametric amplifiers, generators and oscillators are suitable for most of spectroscopy need and other applications, where variety of wavelengths are considered an advantage. However, such devices are extremely expensive and need significant amount of skills to operate.

Sum-frequency generation (SFG), difference frequency generation (DFG), four-wave mixing (FWM) lasers provide another alternative to demanding spectroscopy needs, but in order to achieve exotic wavelengths, complicated laser designs are employed, whereas several separate pump lasers are used to pump a non-linear crystal or complicated cavity designs are provided for effective amplification and mixing of several wavelengths.

A US patent application No. US2009207868, published on Aug. 20, 2009 describes a tunable laser, which includes dispersion optics for separating generated laser pulses into first and second wavelength pulses directed along first and second optical paths. First and second reflective mirrors are disposed in the first and second optical paths, respectively. The laser's output mirror is partially reflective and partially transmissive with respect to the first wavelength and the second wavelength in accordance with provided criteria. A first resonator length is defined between the output mirror and the first mirror, while a second resonator length is defined between the output mirror and the second mirror. The second resonator length is a function of the first resonator length.

Another U.S. Pat. No. 5,345,457 describes a dual-wavelength laser system with intracavity, sum-frequency mixing including a bifurcated resonant cavity having a first arm, a second arm and a common arm; a first laser element located in the first arm for providing a first input laser beam of a first wavelength; a second laser element located in the second arm for providing a second input laser beam of a second wavelength; a nonlinear-mixing element in the common arm; and a beam combining device for combining the first and second beams and submitting them to the nonlinear-mixing element for providing an output laser beam of a third wavelength whose energy is the sum of the energy of the input laser beams.

Other ways of achieving simplified laser cavities for SFG, DFG, FWM involves use of complex reflective coatings with different reflectivity for each of wavelengths to be amplified at desired ratio of average power. In such arrangement it is very difficult to achieve high luminous efficiency from the pump optical power to the output radiation.

Prior art inventions provide capability of simultaneous generation of several wavelength radiation and mixing thereof. However simplified and cost effective optical designs for the same purpose are still missing.

Herein and further, expressions ‘mixing’ or ‘wave mixing’ refer to any of SFG, DFG, FWM or similar non-linear processes and principles.

### SUMMARY

An object of the present invention is to provide a laser source capable of simultaneously generating several wavelength radiation at desired power ratio between each other and/or mixing of said wavelengths in a non-linear optical media in order to achieve different wavelength radiation than those amplified in the gain media.

In the most preferred embodiment, a laser source comprises a dispersive optical element, placed in an optical cavity, having a single optical axis. The dispersive element causes different wavelength radiation to travel in slightly different optical paths through the dispersive element. Tuning of the laser is performed by moving or tilting the dispersive element with respect to the axis of the cavity. As a result, desired ratio or proportions of average power are achieved for each of said wavelengths.

Having the ability to change the power ratio is important for achieving simultaneous generation of several wavelengths in a single gain media, thus avoiding depletion of the exited state by the dominant wavelength.

### DESCRIPTION OF DRAWINGS

In order to better understand the invention, and appreciate its practical applications, the following pictures are provided and referenced hereafter. Figures are given as examples only and in no way limit the scope of the invention.

FIG. 1. illustrates different micro laser designs, where each layout comprises different configuration output coupler;

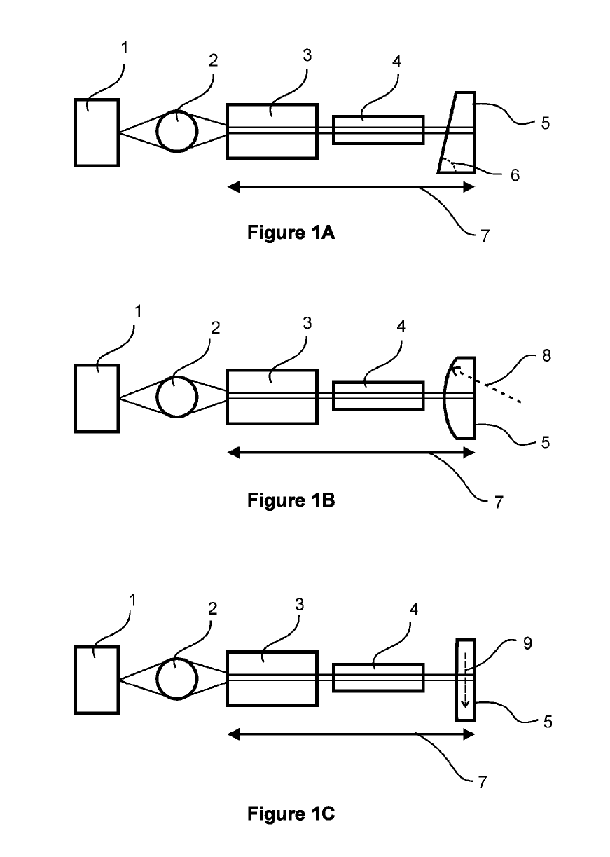

FIG. 2. a close-up view of different configuration output couplers. Thick lines to the left of the output coupler (5.1, 5.2, 5.3) correspond to an incident laser beam, while two thinner lines inside the outline of the output coupler illustrate paths of different wavelength radiation inside the output coupler, whereas one line falls perpendicularly into the second surface (11) of the output coupler and the other line falls into the second surface (11) at some deviation form a normal. The obvious separation between the two lines inside the output coupler is provided just for better illustration, in reality this separation is diminishing small.

### DETAILED DESCRIPTION OF PREFERRED EMBODIMENTS

An object of this invention is a laser source, which can be arranged to radiate many different, traditional and exotic wavelengths one at a time or several simultaneously. Laser optical design is simplified to a essentially single-axis resonator and different wavelengths are amplified as active media-specific emission wavelengths or generated by means of second harmonic generation (SHG), sum-frequency generation (SFG), difference-frequency generation (DFG) or four-wave intra-cavity mixing (FWM). As a result, variety of output wavelengths can be obtained for lasing media, which features more than one characteristic emission lines. For example, Nd:YAG lasing media features 4 key emission lines, when pumped with 808 nm pump beam. The characteristic emission for lines Nd:YAG are 946 nm, 1064 nm, 1123 nm and 1319 nm. Second harmonic generated from these characteristic emission lines would be 473 nm, 532 nm, 562 nm and 660 nm. However, most of these fundamental and second harmonic wavelengths, except 1064 nm and 532 nm are not easily amplified because of dominating 1064 nm radiation, which strongly depletes the excited state. Willing to amplify laser radiation for other, non-dominant emission lines, the cavity has to be optimized in such way, that 1064 nm radiation would be suppressed and good amplification conditions are created for certain weaker emission line.

Similarly, radiation of higher harmonics and emission lines occurring from wave mixing—all of them can be amplified individually or in groups if certain conditions are met to suppress some radiation and stimulate other radiation. In other words, means for changing a ratio for amplification/generation between each of the wavelengths is needed. Herein and further in this description, by saying amplification, we mean both or any of generation of laser radiation from quantum noise or amplification from a signal, which is already generated or seeded.

In the most preferred embodiment, a dispersive element (5.1, 5.2, 5.3) is placed in the resonator and causes different wavelengths to travel in a slightly different optical path. As a result, walk-off losses appear for each wavelength separately, i.e. different amplification/generation conditions are created for each of said wavelengths. The amplification/generation ratio is adjusted by tilting the dispersive element (5.1, 5.2, 5.3) with respect to the cavity axis and/or by moving it along the cavity axis. As a result, one dominant wavelength radiation can be suppressed and another can have favourable conditions to be amplified.

Yet in another embodiment, the dispersive element (5.1, 5.2, 5.3) is formed as an output coupler (in other words, a decoupling mirror). A composite reflective coating is applied to the end surface of the dispersive element (5.1, 5.2, 5.3) and partially or totally reflects radiation of desired wavelengths back to the cavity. Reflection can be selected differently for each of selected wavelengths. For undesired wavelengths the coatings are preferably made transparent, thus avoiding waste depletion of the excited state.

Yet in another embodiment, the dispersive element is prism type element (5.1), having two flat surfaces inclined with respect to each other. In other words, at least one of the surfaces is wedged with respect to the optical axis of the cavity. The angle between the wedged surface and the optical axis is calculated by taking in mind wavelengths, which will be amplified. In order to have minimum walk-off losses for a wavelength, the wedged optical component should be arranged so that after refraction on the first surface, the beam would fall perpendicularly to the second surface. In such arrangement, at least portion of the radiation reflects from the second surface and travels back to the cavity via the same optical path, which ensures best possible amplification conditions. Whereas the wavelength, which is to be suppressed falls into the second surface of the wedged element at some angle, slightly different from a normal, thus it experiences walk-off losses when coming back to the cavity.

It should be appreciated, that a person skilled in the art can use this technique in various ways in order to set desired ratio of amplification between several wavelengths. Application of different reflective and antireflection coatings to the surfaces of the dispersive element is a common skill and knowledge of a laser engineer, thus this invention is not limited to certain geometry of the dispersive element (5.1, 5.2, 5.3) as well as coatings applied thereto. We indicate different examples and configurations of the dispersive element (5.1, 5.2, 5.3) in order to provide a guiding for proper embodiment of this invention.

Yet in another embodiment, the dispersive optical element is an element featuring a curved surface, such as lens or a portion of a lens (5.2). Depending of the position of the curved surface with respect to the optical axis of the cavity, different angle of beam incidence can be adjusted. In this respect, an element having a curved surface (5.2) is more universal than the wedged dispersive element (5.1) as described above.

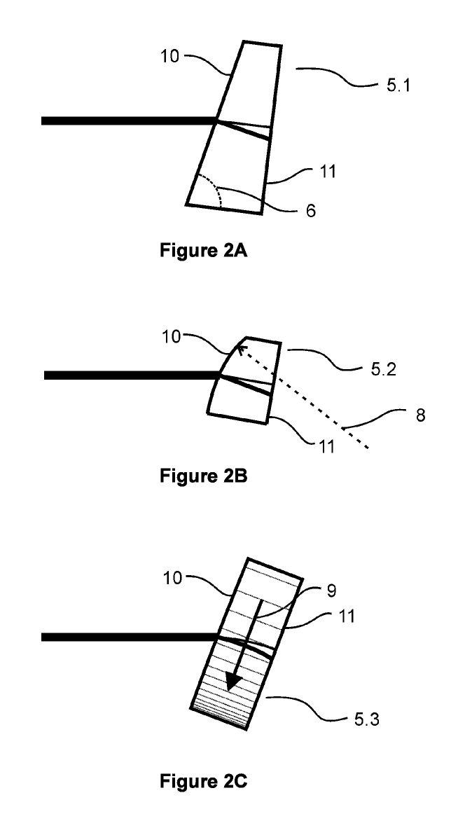

Yet in another embodiment, the dispersive element is a gradient-index plate (5.3). Gradient-index optical element is an element, which features gradual variation of the refractive index (9) of a material. First (10) and second (11) surfaces of such dispersive element are preferably parallel to each other. The refractive index changes gradually in the direction, which is essentially perpendicular to the optical path of the radiation inside the plate. The gradient-index plate (5.3) is preferably angled with respect to the incident radiation. In such arrangement, the optical path inside the gradient-index plate (5.3) is slightly curved, as shown in FIG. 2. Best amplification conditions are met in case the beam falls perpendicularly to the second surface (11) of the gradient-index plate (5.3). This embodiment causes no aberrations. It is apparent to a person skilled-in-the-art that more complex variations of the refractive index can be used in order to achieve desired results with this technique.

In the most simplified embodiment, the optical laser design comprises a pump module (1), preferably a laser diode, collimation optics (2), a gain media (3) and an output coupler (5). First reflecting surface (or coupling mirror) of the laser cavity can be formed as a separate mirror element (not shown in the Figures) or a reflecting coating can be formed on the first end of the gain media (3). The decoupling mirror can be formed as a separate optical component, or it can be formed on the end surface of the dispersive element (5).

Yet in another embodiment, two or more different gain media elements (3) are arranged on the optical axis and two or more of the characteristic wavelengths (at least one wavelength from each gain media) are selected and the cavity (7) is optimized for amplification of said selected wavelength radiation at desired power levels.

Yet in another embodiment, an optical element having X⁽²⁾ non-linearity (4) is arranged in the cavity to provide frequency doubling of the fundamental wavelengths, sum-frequency generation or difference-frequency generation.

Yet in another embodiment, an optical element having X⁽³⁾ non-linearity (4) is arranged in the cavity to provide four-wave mixing or parametric amplification/oscillation/generation.

The laser beam decoupling mirror can be arranged together with the dispersive element as a single optical device, whereas a flat edge of the dispersive element is provided with a reflective coating.

By saying dispersive element we mean any optical element, which causes different wavelength (or frequency) radiation to travel in different paths due to refraction on a surface of the optical element, according to Snell's law or due to refraction inside material because of change of optical properties throughout the aperture or transverse dimensions of the optical element.

As an example of this invention, we provide a description of achieving yellow-orange or 589 nm wavelength radiation by using the technique described above. 589 nm radiation is achieved by sum-frequency generation process, where two infrared wavelengths, which correspond to emission lines of a neodymium doped crystal are summed in a non-linear media, such as BBO, LBO, KDP or other.

In one exemplary embodiment, 1064 nm and 1319 nm emission lines are amplified simultaneously. 1064 nm radiation is suppressed by inducing walk-off losses in a dispersive element and optimal amplification conditions are met for the non-dominant 1319 nm emission line. Sum-frequency for the indicated emission lines is 589 nm, which corresponds to yellow-orange radiation. Similarly, 607 nm, 551 nm, 546 nm, 513 nm and 501 nm radiation can be achieved by summing any 2 of 4 characteristic emission lines of Nd:YAG lasing media. By contraries, in a difference frequency generation process, wavelengths of far- and mid-infrared could be generated. For the same Nd:YAG lasing media, the resulting wavelenghts of DFG are 5504 nm, 3345 nm, 8530 nm, 6002 nm, 7557 nm and 20252 nm. Setting a good power ratio between two beams of different wavelengths is very important for achieving good efficiency of the SFG or DFG processes.

Different wavelength sets can be calculated for any lasing media having several characteristic emission lines. Lasing media, such as Nd:YAG, Nd:YLF, Nd:YAP, Nd:LSB, Nd:GLASS, Ti:Sapphire, Er:YAG and many more can be used to gain benefit from this invention and a person skilled in the art should be able to readily use those materials using the principles described herein in order to implement this invention.

This invention should not be limited to certain gain media or combination thereof. Both, several wavelengths from a single gain media or several wavelength radiation from a combination of two or more gain media crystals, are applicable and provide wide capabilities of generating exotic wavelengths.

Other non-linear processes, such as generation of third, fourth and higher harmonics are essentially specific cases of sum-frequency generation, therefore it will be not analyzed herein in detail. For a person skilled in the art it should be obvious, how radiation of several different wavelengths, with a controlled power ratio, could be used to generate other wavelength radiation whether inside the cavity (7) or outside.

1. A laser system configured to at least one of (a) generate and (b) amplify multiple wavelengths of laser radiation, the system comprising:
a lasing medium positioned on a single optical axis,
multiple reflective or partially reflective surfaces configured to reflect each of the wavelengths of radiation by forming an optical resonator for each of the wavelengths of radiation, and
an optical element having a dispersive property,
wherein the reflective or partially reflective surfaces are configured to be tuned to change an amplification ratio between each of the wavelengths of radiation, and
wherein the reflective or partially reflective surfaces are fixedly arranged with respect to each other and are configured to be tuned simultaneously when tuning the optical resonators of each of the wavelengths of radiation to a desired ratio of amplification between radiation of the wavelengths of radiation.

2. The system according to claim 1, further comprising a dispersive element comprising the multiple reflective or partially reflective surfaces, wherein the dispersive element comprises at least one of a prism, a wedge, a lens, and a gradient-index optical element.

3. The system according to claim 1, wherein the lasing medium comprises a single lasing material having two or more emission lines.

4. The system according to claim 1, wherein the lasing medium comprises two or more lasing materials, and wherein one or more emission lines are used from each of the two or more lasing materials.

5. The system according to claim 1, wherein the system further comprises at least one of a nonlinear optical medium and non-linear optical media that is configured to be used inside or outside of each of the optical resonators for at least one of harmonic generation, sum-frequency generation, difference-frequency generation, and four-wave mixing.

6. The system according to claim 5, wherein the at least one of the nonlinear optical medium and nonlinear optical media comprises a material of an χ⁽²⁾ non-linearity.

7. The system according to claim 5, wherein the at least one of the nonlinear optical medium and the nonlinear optical media comprises a material of an χ⁽³⁾ non-linearity.

8. A system according to claim 1, wherein each of the optical resonators is arranged for simultaneous amplification of two wavelengths of radiation.

9. A system according to claim 8, wherein at least one of the multiple reflective or partially reflective surfaces is configured to reflect the two wavelengths of radiation, is formed on a single surface of a dispersive optical element in the system, and wherein a collinear resonator is formed in the system for the two wavelengths of radiation, and whereas the dispersive optical element is arranged inside of each of the optical resonators.

10 A laser apparatus, comprising:
a pump source,
a gain medium, and
multiple reflective or partially reflective surfaces,
wherein the apparatus is configured such that radiation of at least two different wavelengths is able to be simultaneously amplified in a single optical cavity of the apparatus, and wherein a power ratio between said radiations of different wavelengths is configured to be adjusted by tuning the reflective or partially reflective surfaces such that an amplification ratio between each of the wavelengths of radiation is changed, and wherein the reflective or partially reflective surfaces are fixedly arranged with respect to each other and are configured to be tuned simultaneously when tuning the optical resonators of each of the wavelengths of radiation to a desired ratio of amplification between radiation of the wavelengths of radiation.

11. The system according to claim 2, Wherein the lasing medium comprises a single lasing material having two or more emission lines.

12. The system according to claim 2, wherein the lasing medium comprises two or more lasing materials, and wherein one or more emission lines are used from each of the two or more lasing materials.

13. The system according to claim 2, wherein the system further comprises at least one of a nonlinear optical medium and non-linear optical media that is configured to be used inside or outside of each of the optical resonators for at least one of harmonic generation, sum-frequency generation, difference-frequency generation, and four-wave mixing.

14. The system according to claim 3, wherein the system further comprises at least one of a nonlinear optical medium and non-linear optical media that is configured to be used inside or outside of each of the optical resonators for at least one of harmonic generation, sum-frequency generation, difference-frequency generation, and four-wave mixing.

15. The system according to claim 4, wherein the system further comprises at least one of a nonlinear optical medium and non-linear optical media that is configured to be used inside or outside of each of the optical resonators for at least one of harmonic generation, sum-frequency generation, difference-frequency generation, and four-wave mixing.

16. A system according to claim 2, wherein each of the optical resonators is arranged for simultaneous amplification of two wavelengths of radiation.

17. A system according to claim 3, wherein each of the optical resonators is arranged for simultaneous amplification of two wavelengths of radiation.

18. A system according to claim 5, wherein each of the optical resonators is arranged for simultaneous amplification of two wavelengths of radiation.

19. A system according to claim 6, wherein each of the optical resonators is arranged for simultaneous amplification of two wavelengths of radiation.

20. A system according to claim 7, wherein each of the optical resonators is arranged for simultaneous amplification of two wavelengths of radiation.
